(19) United States
(12) Patent Application Publication
(10) Pub. No.: US 2010/0182674 A1
(43) Pub. Date: Jul. 22, 2010

(54) SYSTEM INCLUDING ENCLOSURE HAVING SMART GLASS PANEL AND RELATED METHOD

(75) Inventor: Michael J. Nichols, Brookline, MA (US)

Correspondence Address: HOFFMAN WARNICK LLC, 75 STATE STREET, 14TH FLOOR, ALBANY, NY, 12207, US

(73) Assignee: HIRES BIOSOLUTIONS, Woburn, MA (US)

(21) Appl. No.: 12/691,180

(22) Filed: Jan. 21, 2010

Related U.S. Application Data
(60) Provisional application No. 61/146,059, filed on Jan. 21, 2009.

(51) Int. Cl. G02F 1/01; G02F 1/153; G02F 1/167; G02F 1/1334

(52) U.S. Cl. 359/275; 359/238; 359/296; 349/16

(57) ABSTRACT

System including enclosure having smart glass panels and related method.

### BACKGROUND OF THE INVENTION

The disclosure relates generally to equipment enclosure systems and more particularly to automated testing system arrangement using an enclosure having smart glass panels.

A number of automated processes, including but not limited to chemical and biological assays, use light-sensitive elements, and must be performed in the absence of either visible light or light of certain wavelengths. In these circumstances, the presence of light during experiments is considered a contaminant that can compromise experimental results.

### BRIEF DESCRIPTION OF THE INVENTION

A first aspect of the disclosure provides a system comprising: an enclosure including a plurality of sides; and a smart glass panel in at least one of the plurality of sides, the smart glass panel including at least a pair of settings, each setting having a different light transmission property.

A second aspect of the disclosure provides a method comprising: providing a system having an enclosure having a plurality of sides for enclosing testing equipment and a smart glass panel in at least one of the plurality of sides, the smart glass panel including at least a pair of settings each having a different light transmission property; setting an amount of light entering the enclosure by selecting the setting of the smart glass panel; and performing testing using the testing equipment.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

FIG. 1-8 show embodiments of a system and method according to the invention.

### DETAILED DESCRIPTION OF THE INVENTION

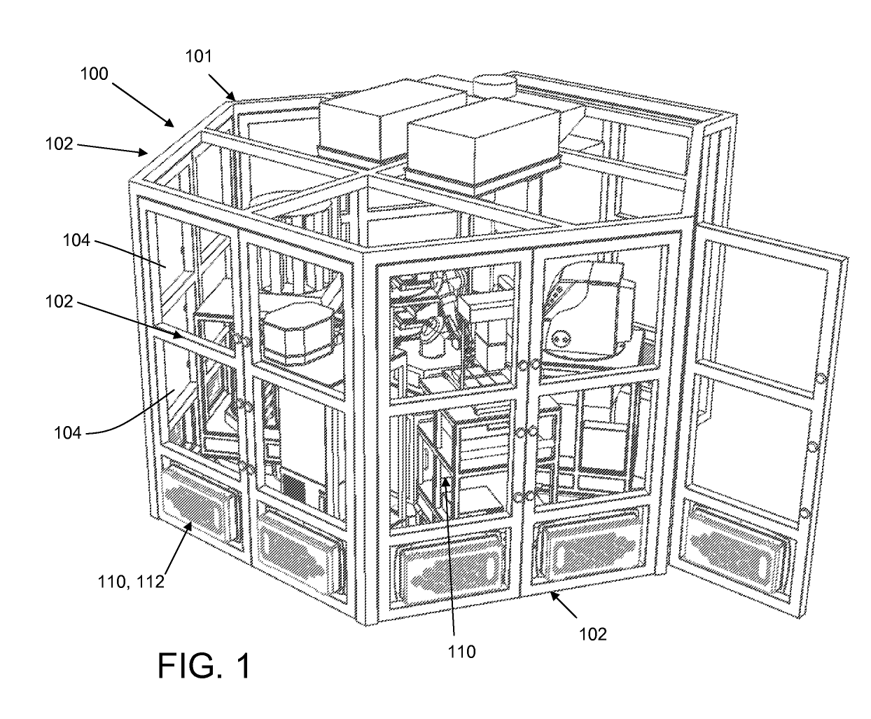

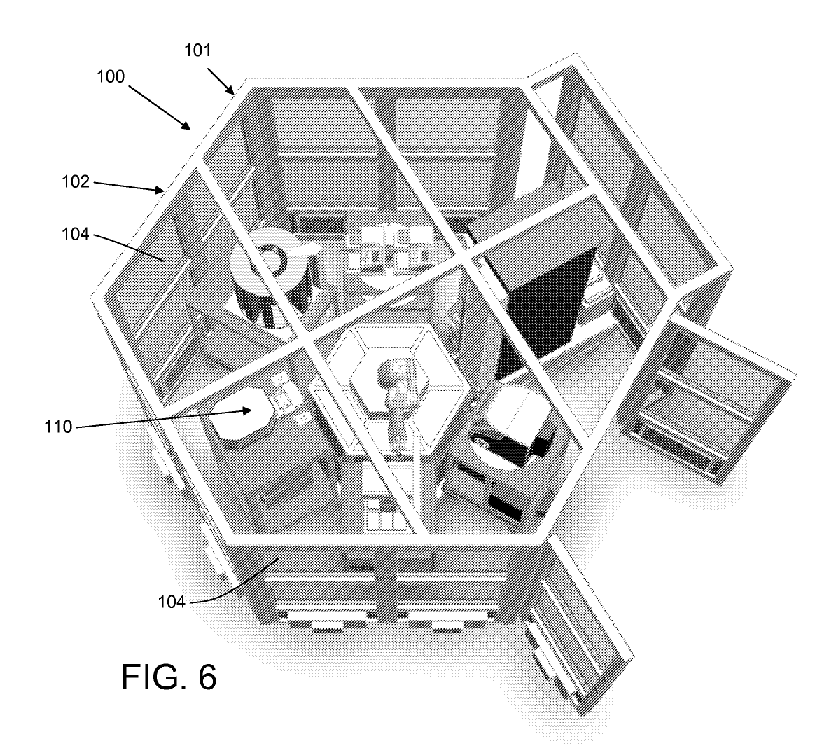

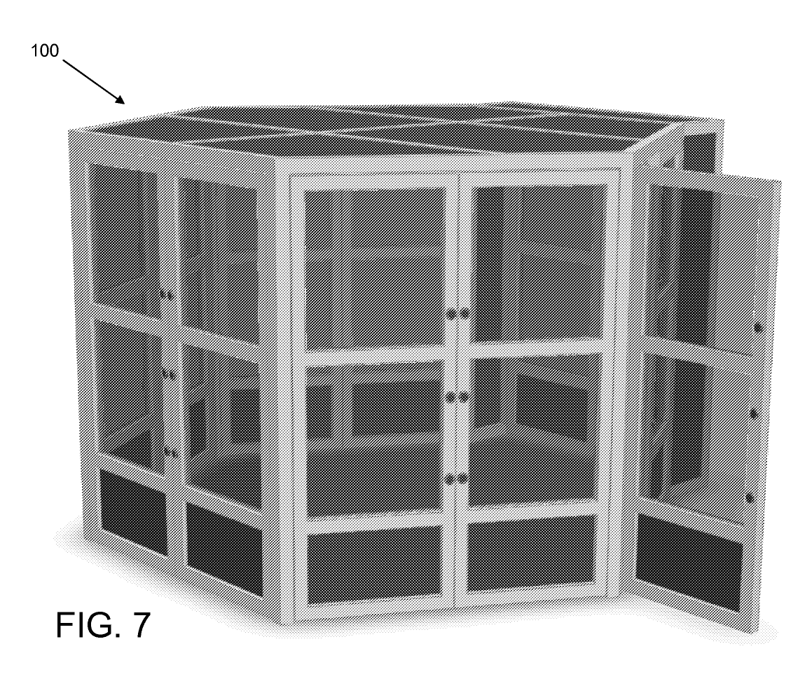

FIGS. 1-8 show embodiments of a system 100 and method according to the invention. System 100 may include an enclosure 101 including a plurality of sides 102, and a smart glass panel 104 in at least one of the plurality of sides. Smart glass panel 104 may include any now known or later developed panel capable of being set at least a pair of settings, where each setting has a different light transmission property. In one embodiment, smart glass panel 104 may include an electrochromic device, a suspended particle device, a polymer dispersed liquid crystal device, or any other device capable of a, for example, electrically, controlled light transmission setting.

In operation, system 100 is provided having enclosure 101 having plurality of sides 102 for enclosing testing equipment 110 and smart glass panel 104 in at least one of the plurality of sides. An amount of light entering enclosure 101 is selected by selecting the setting of smart glass panel 104. In one embodiment, a pair of settings may be provided: a transparent setting in which the smart glass panel is transparent and allows light into the enclosure and an opaque setting in which the smart glass panel is opaque and prevents light from entering into the enclosure. Settings, however, need not be limited to these two as a variety of different settings, each allowing a different amount of light transmission may be employed. That is, in other embodiments, translucent settings having light transmission properties between transparent and opaque may be employed. For example, there may exist settings which allow only certain wavelengths of light to pass through or which only block certain wavelengths of light. Testing using testing equipment 110 for which all light, no light or only certain light exposure is allowed may then be performed using system 100.

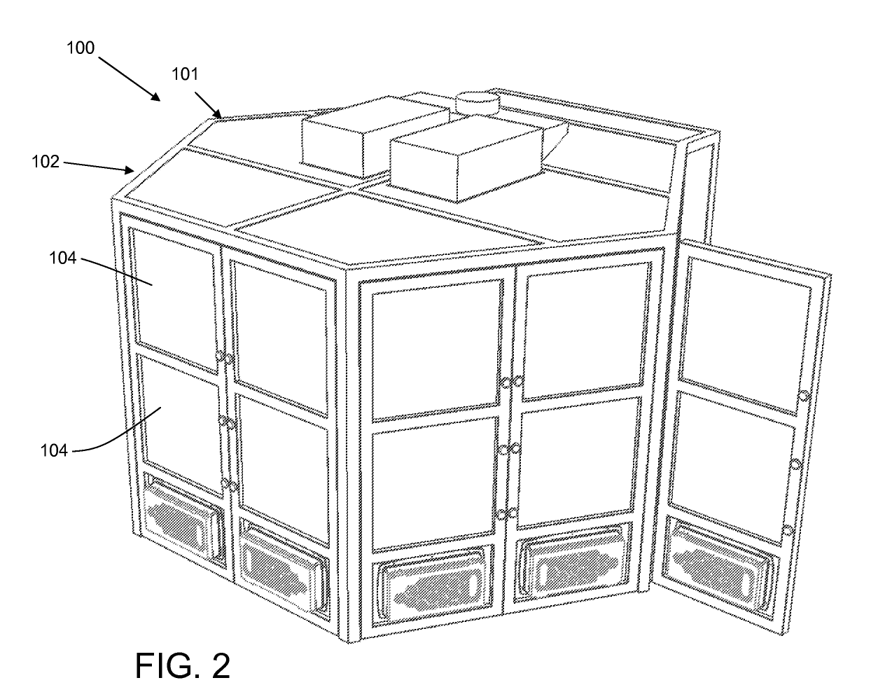

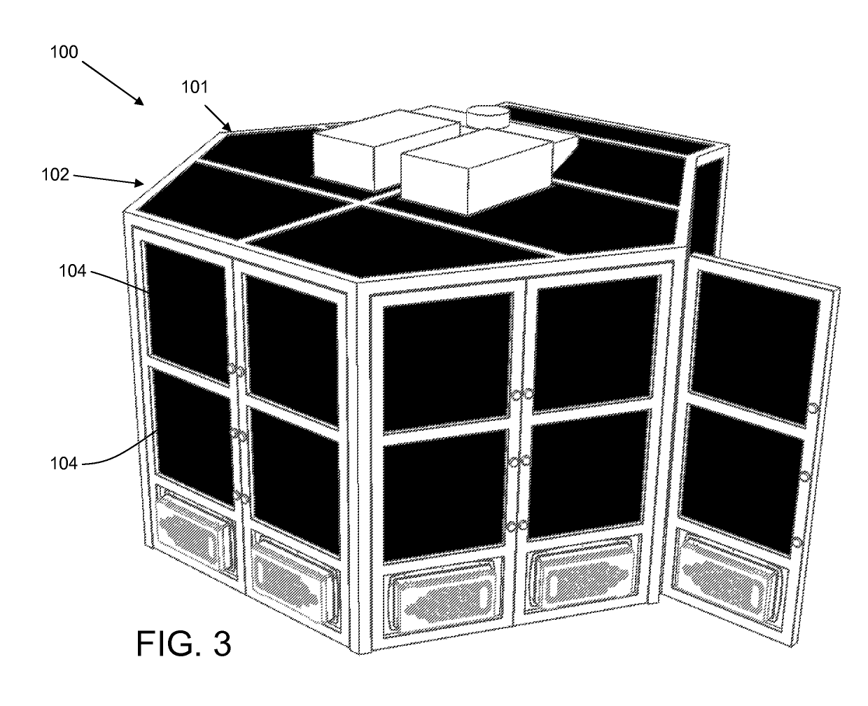

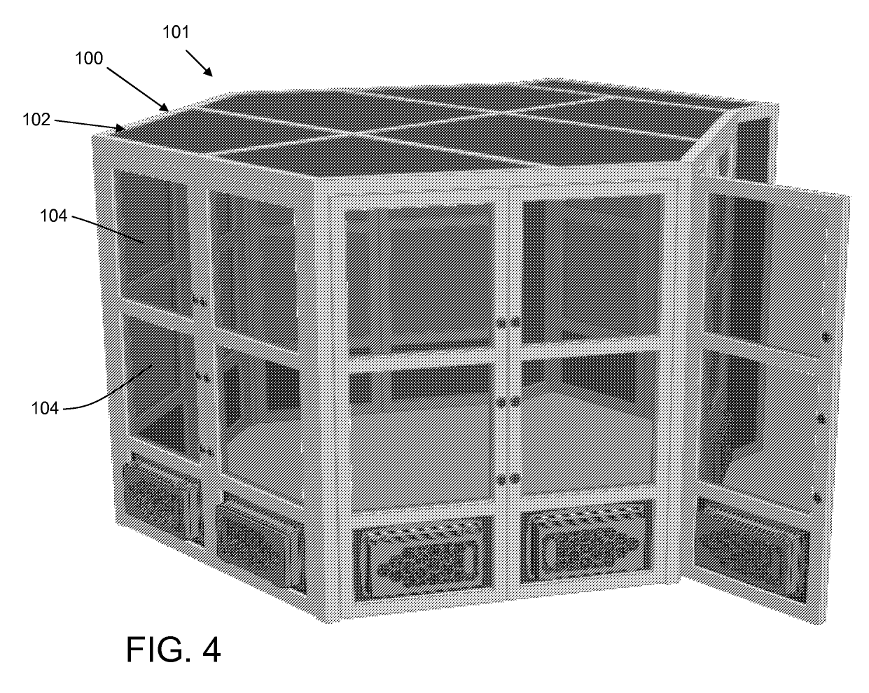

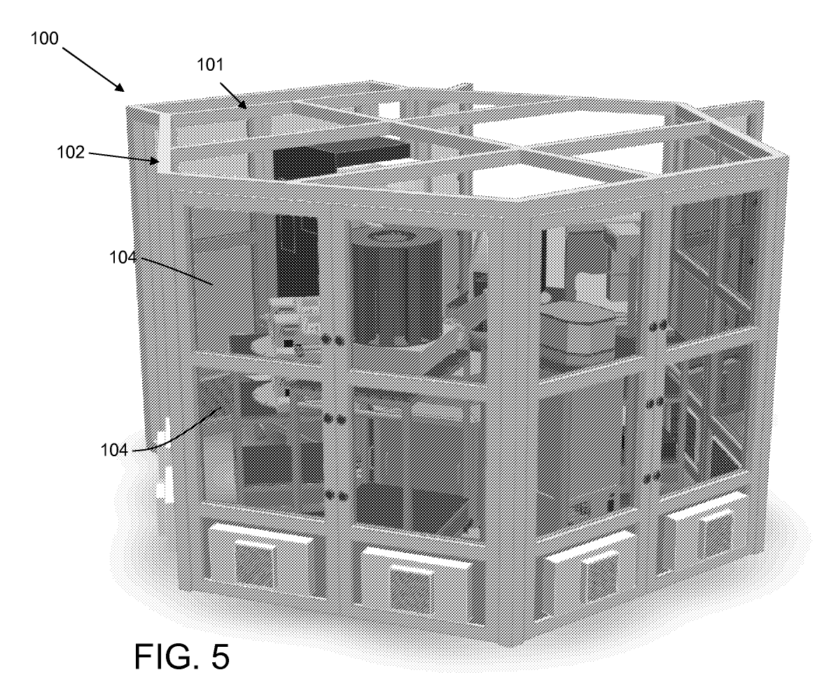

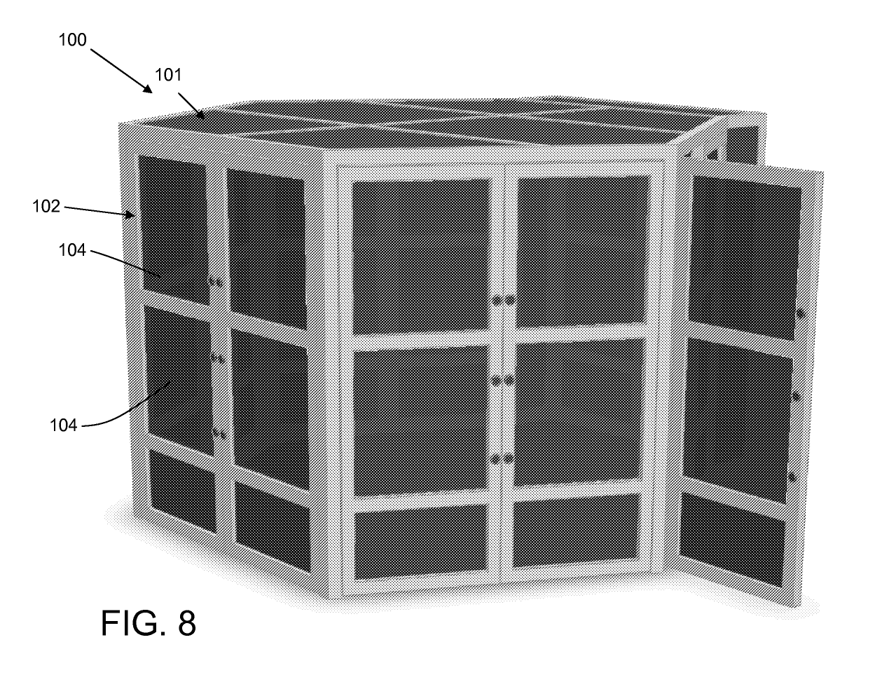

As illustrated, each panel 104 in each of plurality of sides 102 includes a smart glass panel. However, as one with skill in the art would understand, where only limited light transmission control is required, not all of the glass in sides 102 need include smart glass panels. FIGS. 1 and 5 show system 100 with smart glass panels 104 in a transparent setting. FIGS. 2, 3 and 8 show smart glass panels 104 in an opaque setting with FIG. 2 showing an embodiment in which panels 104 turn white, and FIGS. 3 and 8 showing an embodiment in which panels 104 turn black. FIGS. 4-7 show embodiments of system 100 having varying levels of translucent settings, with FIG. 5 showing an embodiment in which not all of the panels are smart glass, e.g., the top may be non-smart glass transparent panels.

While each side 102 is shown including a plurality of panels 104, each side may include just one panel 104.

Referring to FIG. 1, in one embodiment, system 100 includes an automated control system 112 including a controller 114 for controlling the setting of smart glass panel(s) 104. Automated control system 112 may be provided to control testing equipment 110 or moving materials to be tested. Controller 114 may be part of larger automated control system 112 of a separate entity. In operation, controller 114 may, for example, make panel(s) 104 transparent during set up of testing equipment 110 and opaque or translucent during testing. The location of automated control system 112 and controller 114 may vary from that shown.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system comprising:
an enclosure including a plurality of sides; and
a smart glass panel in at least one of the plurality of sides, the smart glass panel including at least a pair of settings, each setting having a different light transmission property.

2. The system of claim 1, wherein the at least a pair of settings includes a transparent setting in which the smart glass panel is transparent and an opaque setting in which the smart glass panel is opaque.

3. The system of claim 1, wherein each of the plurality of sides includes a smart glass panel.

4. The system of claim 3, wherein the smart glass panel includes a plurality of smart glass panels.

5. The system of claim 3, wherein the at least a pair of settings includes a transparent setting in which the smart glass panel is transparent and allows light into the enclosure and an opaque setting in which the smart glass panel is opaque and prevents light from entering into the enclosure.

6. The system of claim 1, further comprising an automated control system that includes a controller for controlling the setting of the smart glass panel.

7. The system of claim 1, wherein the smart glass panel includes one of an electrochromic device, a suspended particle device and a polymer dispersed liquid crystal device.

8. A method comprising:
providing a system having an enclosure having a plurality of sides for enclosing testing equipment and a smart glass panel in at least one of the plurality of sides, the smart glass panel including at least a pair of settings each having a different light transmission property;
setting an amount of light entering the enclosure by selecting the setting of the smart glass panel; and
performing testing using the testing equipment.

9. The method of claim 8, wherein the at least a pair of settings includes a transparent setting in which the smart glass panel is transparent and an opaque setting in which the smart glass panel is opaque.

10. The method of claim 8, wherein the providing includes providing each of the plurality of sides includes a smart glass panel.

11. The method of claim 10, wherein the providing includes providing the smart glass panel as a plurality of smart glass panels.

12. The method of claim 10, wherein the at least a pair of settings includes a transparent setting in which the smart glass panel is transparent and allows light into the enclosure and an opaque setting in which the smart glass panel is opaque and prevents light from entering into the enclosure.

13. The method of claim 8, wherein the providing further comprises providing an automated control system for the testing equipment,
wherein the automated control system includes a controller for controlling the setting of the smart glass panel.

14. The method of claim 8, wherein the providing includes providing the smart glass panel as one of an electrochromic device, a suspended particle device and a polymer dispersed liquid crystal device.
